(19) United States
(12) Patent Application Publication
(10) Pub. No.: US 2022/0198060 A1
(43) Pub. Date: Jun. 23, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Masayuki YAMAGUCHI, Kanagawa (JP); Yusuke SUZUKI, Kanagawa (JP); Kunihiko KOBAYASHI, Kanagawa (JP); Akinobu YAMAGUCHI, Kanagawa (JP); Kunikazu UENO, Kanagawa (JP)

(73) Assignee: FUJIFILM Business Innovation Corp., Tokyo (JP)

(21) Appl. No.: 17/330,879

(22) Filed: May 26, 2021

(30) Foreign Application Priority Data
Dec. 23, 2020 (JP) 2020-214129

(51) Int. Cl. G06F 21/62; G06F 21/36; G06Q 10/06

(52) U.S. Cl. CPC G06F 21/6254; G06F 21/36; G06Q 10/06395; G06Q 10/06393; G06Q 10/06398

(57) ABSTRACT

An information processing apparatus includes a processor configured to: acquire an image representing an operation screen on which progress of a work is displayed in accordance with a procedure of the work and on which an operator performs an operation, the image being obtained by recording the operation screen; and perform a masking process on information regarding identification of the operator in the acquired image.

### CROSS-REFERENCE TO RELATED APPLICATIONS

This application is based on and claims priority under 35 USC 119 from Japanese Patent Application No. 2020-214129 filed Dec. 23, 2020.

### BACKGROUND

### (i) Technical Field

The present disclosure relates to an information processing apparatus and a non-transitory computer readable medium.

### (ii) Related Art

For example, an information technology (IT) operation work remote support system for supporting operation work of an IT system is described in Japanese Unexamined Patent Application Publication No. 2018-36812. The IT operation work remote support system includes a first portable terminal for a first operator who does field work on an IT system, a second portable terminal for a second operator who does remote work, and a server. Apparatuses composing the IT system are each provided with an ID medium including an ID. Each of the apparatuses includes setting information including information regarding association between the apparatus and the ID, a user ID of the first operator, a user ID of the second operator, and information regarding the right of the second operator to access the apparatus represented by the ID. The server detects an ID of an ID medium from a photographed image obtained by photographing an apparatus by the first operator using a camera, confirms, on the basis of the setting information, whether or not the second operator has the right to access the apparatus represented by the detected ID, performs a masking process on the photographed image to generate a masking image by defining a part of the image of the apparatus that the second operator has the right to access as a non-mask region and a part of the image of the apparatus that the second operator does not have the right to access as a mask region, and provides the masking image to the second portable terminal, so that the masking image is displayed on a display screen.

### SUMMARY

Workflow systems for managing progress of a work in accordance with the procedure of the work are available. In such workflow systems, operations on a specific work are performed by a plurality of operators.

An operation screen to be used by an operator of a workflow system to perform an operation is displayed on a client terminal of the workflow system. The progress of a work is displayed on the operation screen in accordance with the procedure of the work, and the operator performs an operation on the operation screen. In particular, an operator with an excellent operation quality (for example, with a high processing speed, less mistakes, etc.) often uses their ingenuity in the operation screen so that the operation quality is improved. For example, information regarding an operation that is not included in the original operation screen may be displayed superimposed on the operation screen in an appropriate manner.

That is, an operation screen for an operator with an excellent operation quality may be helpful to other operators. Thus, such an operation screen may be recorded and used for education of other operators. However, personal information or the like that identifies an operator is displayed on the operation screen. Thus, recording and using the operation screen on which the personal information or the like of the operator is displayed may make the operator feel uncomfortable.

Aspects of non-limiting embodiments of the present disclosure relate to providing an information processing apparatus and a non-transitory computer readable medium that are capable of protecting information regarding identification of an operator on an operation screen.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire an image representing an operation screen on which progress of a work is displayed in accordance with a procedure of the work and on which an operator performs an operation, the image being obtained by recording the operation screen; and perform a masking process on information regarding identification of the operator in the acquired image.

### BRIEF DESCRIPTION OF THE DRAWINGS

Exemplary embodiments of the present disclosure will be described in detail based on the following figures, wherein:

FIG. 1 is a diagram illustrating an example of a configuration of a workflow system according to a first exemplary embodiment;

FIG. 2 is a block diagram illustrating an example of an electrical configuration of an information processing apparatus according to the first exemplary embodiment;

FIG. 3 is a block diagram illustrating an example of a functional configuration of the information processing apparatus according to the first exemplary embodiment;

FIG. 4 is a diagram illustrating an example of a workflow database according to an exemplary embodiment;

FIG. 5 is a diagram illustrating an example of an operation screen image according to an exemplary embodiment;

FIG. 6 is a diagram illustrating an example of a workflow system screen image before a masking process is performed in an exemplary embodiment;

FIG. 7 is a diagram illustrating an example of a workflow system screen image after a masking process is performed in an exemplary embodiment;

FIG. 8 is a flowchart illustrating an example of the procedure of a learning process based on an information processing program in the first exemplary embodiment;

FIG. 9 is a flowchart illustrating an example of the procedure of a masking process based on an information processing program in the first exemplary embodiment;

FIG. 10 is a block diagram illustrating an example of a functional configuration of an information processing apparatus according to a second exemplary embodiment; and

FIG. 11 is a diagram illustrating an example of an operation screen image in a third exemplary embodiment.

### DETAILED DESCRIPTION

Hereinafter, exemplary embodiments for carrying out the technology of the present disclosure will be descried in detail with reference to drawings. Components and processes that are responsible for the same operations, effects, and functions are assigned the same signs throughout all the drawings, and redundant explanation may be omitted in an appropriate manner. The drawings are merely illustrated schematically, to such an extent that it is enough to understand the technology of the present disclosure. Accordingly, the technology of the present disclosure is not intended to be limited to illustrated examples. In addition, in an exemplary embodiment, explanation for a configuration that is not directly related to the technology of the present disclosure and a well-known configuration may be omitted.

### First Exemplary Embodiment

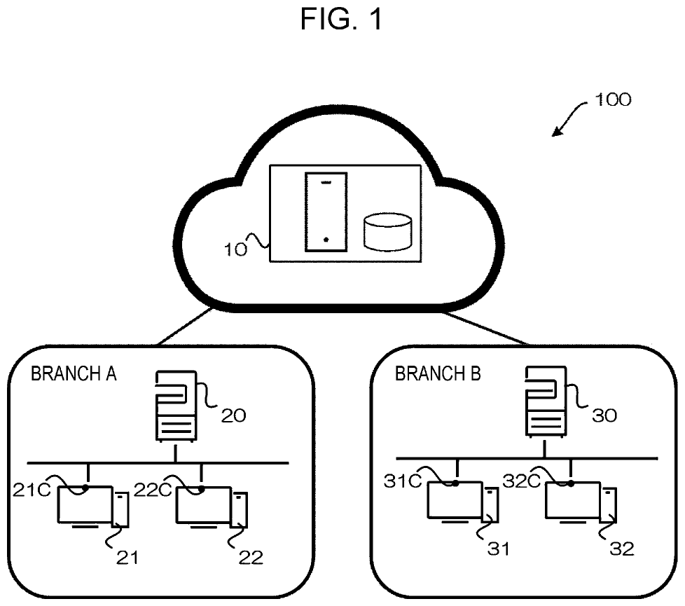

FIG. 1 is a diagram illustrating an example of a configuration of a workflow system 100 according to a first exemplary embodiment.

As illustrated in FIG. 1, the workflow system 100 according to this exemplary embodiment includes an information processing apparatus 10. The information processing apparatus 10 is connected to an image forming apparatus 20 and client terminals 21 and 22 provided in branch A of a business (for example, a bank) via a network and is connected to an image forming apparatus 30 and client terminals 31 and 32 provided in branch B via a network.

The workflow system 100 manages progress of a work in accordance with the procedure of the work. Works include, for example, repetitive works such as a work for applying for opening a bank account and a work for applying for a housing loan. In the case of a work for applying for opening an account, for example, progress of the work including “account opening application”, “first approval (reception desk)”, “second approval (internal processing)”, “account opening acceptance”, and “account opening completion” is managed as a workflow.

The image forming apparatus 20 includes, for example, a copy function, a print function, a facsimile function, a scanner function, and the like and is connected to the client terminals 21 and 22 via a network such as a local area network (LAN). The client terminals 21 and 22 are, for example, general-purpose personal computers (PCs) and function as terminals for the workflow system 100. In a similar manner, the image forming apparatus 30 includes, for example, a copy function, a print function, a facsimile function, a scanner function, and the like and is connected to the client terminals 31 and 32 via a network such as a LAN. The client terminals 31 and 32 are, for example, general-purpose PCs and function as terminals for the workflow system 100. The client terminals 21, 22, 31, and 32 include similar functions as terminals for the workflow system 100.

Each of the client terminals 21, 22, 31, and 32 displays an operation screen on which progress of a work is displayed in accordance with the procedure of the work in the workflow system 100. Operators of the workflow system 100 perform operations on the operation screens. Each of the client terminals 21, 22, 31, and 32 includes a so-called screen recording function (also be called video capture or screen recording) for recording screen transition of an operation screen in accordance with a recording instruction from the information processing apparatus 10. Furthermore, the client terminals 21, 22, 31, and 32 include in-cameras 21C, 22C, 31C, and 32C, respectively. Operators who perform operations on the operation screens may be photographed as necessary, for example, in a web meeting. Hereinafter, in the case where the client terminals 21, 22, 31, and 32 do not need to be distinguished from one another, the client terminal 21 will be explained a representative example.

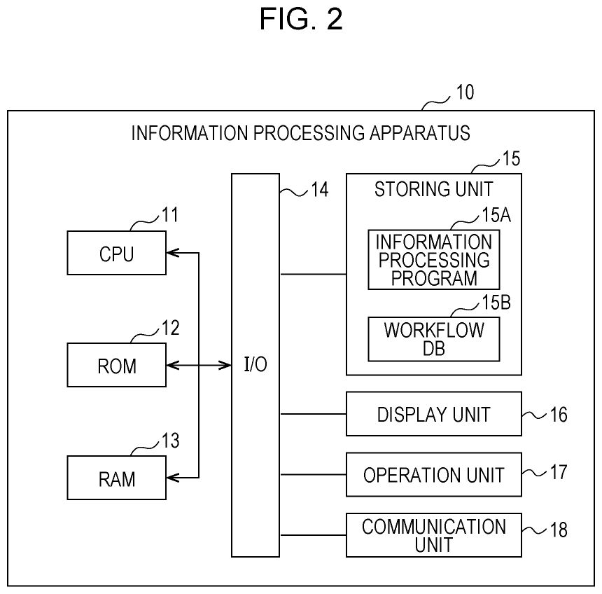

FIG. 2 is a block diagram illustrating an example of an electrical configuration of the information processing apparatus 10 according to the first exemplary embodiment.

As illustrated in FIG. 2, the information processing apparatus 10 according to this exemplary embodiment includes a central processing unit (CPU) 11, a read only memory (ROM) 12, a random access memory (RAM) 13, an input/output interface (I/O) 14, a storing unit 15, a display unit 16, an operation unit 17, and a communication unit 18.

The information processing apparatus 10 according to this exemplary embodiment is, for example, a server computer or a general-purpose computer such as a PC.

The CPU 11, the ROM 12, the RAM 13, and the I/O 14 are connected to one another via a bus. Functional units including the storing unit 15, the display unit 16, the operation unit 17, and the communication unit 18 are connected to the I/O 14. These functional units are able to communicate with the CPU 11 via the I/O 14.

The CPU 11, the ROM 12, the RAM 13, and the I/O 14 configure a controller. The controller may be configured to be a sub-controller that controls part of operation of the information processing apparatus 10 or may be configured to be part of a main controller that controls the entire operation of the information processing apparatus 10. Part of or all the blocks of the controller may be, for example, an integrated circuit such as large scale integration (LSI) or an integrated circuit (IC) chip set. The blocks may be separate circuits or partially or entirely integrated circuits. The blocks may be integrated together or part of blocks may be provided separately. Furthermore, part of each of the blocks may be provided separately. Integration of the controller is not necessarily based on LSI. Dedicated circuits or general-purpose processors may be used.

The storing unit 15 is, for example, a hard disk drive (HDD), a solid state drive (SSD), a flash memory, or the like. An information processing program 15A according to an exemplary embodiment is stored in the storing unit 15. The information processing program 15A may be stored in the ROM 12. Furthermore, a workflow database (hereinafter, referred to as a “workflow DB”) 15B is stored in the storing unit 15. The workflow DB 15B is not necessarily stored in the storing unit 15. For example, the workflow DB 15B may be stored in an external storage device.

The information processing program 15A may be, for example, installed in advance in the information processing apparatus 10. The information processing program 15A may be implemented by being stored in a non-volatile storage medium or distributed via a network and installed into the information processing apparatus 10 in an appropriate manner. The non-volatile storage medium may be, for example, a compact disc-read only memory (CD-ROM), a magneto-optical disk, an HDD, a digital versatile disc-read only memory (DVD-ROM), a flash memory, a memory card, or the like.

The display unit 16 may be, for example, a liquid crystal display (LCD), an organic electroluminescence (EL) display, or the like. The display unit 16 may include a touch panel in an integrated manner. The operation unit 17 includes operation input devices such as a keyboard, a mouse, and the like. The display unit 16 and the operation unit 17 receive various instructions from a user of the information processing apparatus 10. The display unit 16 displays various types of information including a result of a process performed in response to an instruction received from the user and a notification regarding the process.

The communication unit 18 is connected to a network such as the Internet, a LAN, or a wide area network (WAN). The communication unit 18 is able to communicate with external apparatuses such as the image forming apparatuses 20 and 30 and the client terminals 21, 22, 31, and 32 via a network.

As described above, in particular, an operator with an excellent operation quality (for example, with a high processing speed, less mistakes, etc.) often uses their ingenuity in the operation screen so that the operation quality is improved. For example, information regarding an operation that is not included in the original operation screen may be displayed superimposed on the operation screen in an appropriate manner.

That is, an operation screen for an operator with an excellent operation quality may be helpful to other operators. Thus, such an operation screen may be recorded and used for education of other operators. However, personal information or the like that identifies an operator is displayed on the operation screen. Thus, recording and using the operation screen on which the personal information or the like of the operator is displayed may make the operator feel uncomfortable.

The information processing apparatus 10 according to this exemplary embodiment performs a masking process, in an image obtained by recording an operation screen on which progress of a work is displayed in accordance with the procedure of the work, on information regarding identification of an operator who performs an operation on the operation screen.

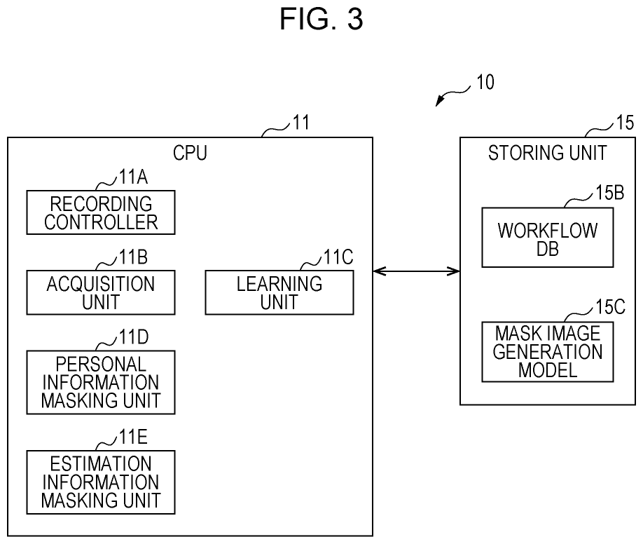

Specifically, the CPU 11 of the information processing apparatus 10 according to this exemplary embodiment functions as units illustrated in FIG. 3 by writing the information processing program 15A stored in the storing unit 15 into the RAM 13 and executing the information processing program 15A. The CPU 11 is an example of a processor.

FIG. 3 is a block diagram illustrating an example of a functional configuration of the information processing apparatus 10 according to the first exemplary embodiment.

As illustrated in FIG. 3, the CPU 11 of the information processing apparatus 10 according to this exemplary embodiment functions as a recording controller 11A, an acquisition unit 11B, a learning unit 11C, a personal information masking unit 11D, and an estimation information masking unit 11E.

The workflow DB 15B and a mask image generation model 15C are stored in the storing unit 15 in this exemplary embodiment.

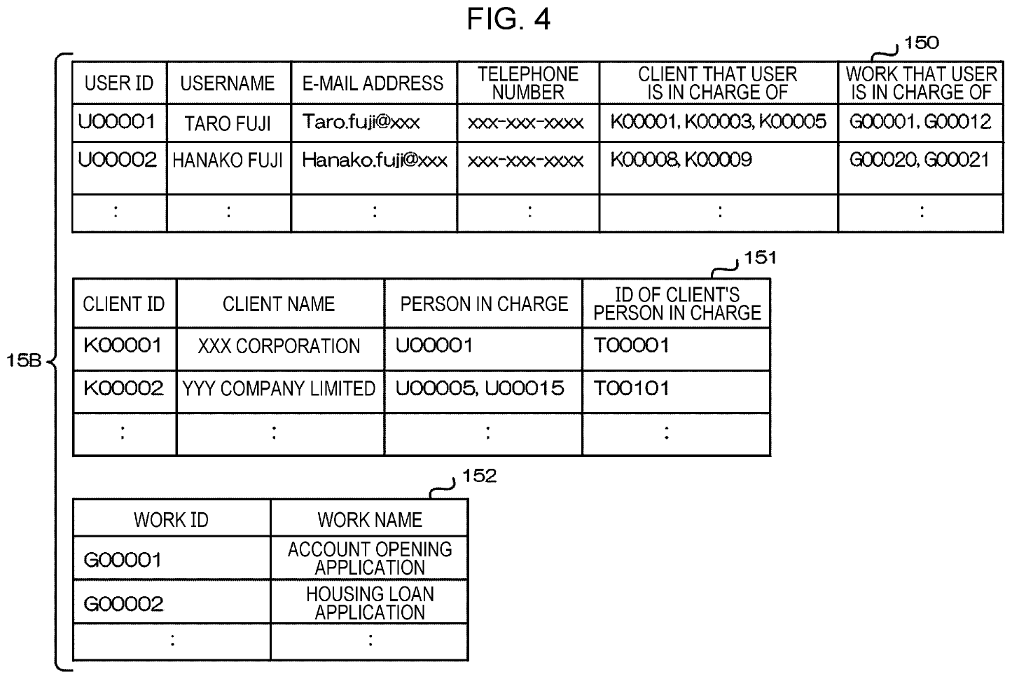

FIG. 4 is a diagram illustrating an example of the workflow DB 15B in this exemplary embodiment.

The workflow DB 15B illustrated in FIG. 4 includes a user management table 150, a client table 151, and a work table 152.

The user management table 150 is a table for managing information regarding an operator (that is, a user) of the workflow system 100. For example, information including a user identification (ID), a username, an e-mail address, a telephone number, a client that a user is in charge of, a work that a user is in charge of, and the like is registered in the user management table 150. The client table 151 is a table for managing information regarding a client that an operator (user) of the workflow system 100 is in charge of. For example, information including a client ID, a client name, a person in charge, an ID of a client's person in charge, and the like is registered in the client table 151. A client ID in the client table 151 corresponds to a client that a user is in charge of in the user management table 150, and a person in charge in the client table 151 corresponds to a user ID in the user management table 150. Furthermore, for an ID of a client's person in charge in the client table 151, a table in which information including a username, an e-mail address, a telephone number, and the like is registered as with the user management table 150 is provided. The work table 152 is a table for managing information regarding a work that an operator (user) of the workflow system 100 is in charge of. For example, information including a work ID, a work name, and the like is registered in the work table 152. A work ID in the work table 152 corresponds to a work that a user is in charge of in the user management table 150.

Referring to FIG. 3, the recording controller 11A performs control for recording an operation screen for the client terminal 21. For example, recording of an operation screen starts when an operator logs into the workflow system 100 using the client terminal 21 and ends when the operator logs out of the workflow system 100. In this exemplary embodiment, it is assumed that the fact that an operator of the client terminal 21 is an operator with an excellent operation quality is known in advance.

The acquisition unit 11B acquires an image representing an operation screen (hereinafter, referred to as an “operation screen image”) obtained by recording an operation screen for the client terminal 21. The operation screen image acquired by the acquisition unit 11B is stored in, for example, the storing unit 15.

The learning unit 11C performs machine learning of a previously obtained operation screen image group as learning data. Thus, the learning unit 11C generates the mask image generation model 15C that inputs an operation screen image on which a masking process has not yet been performed and outputs an operation screen image on which a masking process has been performed. That is, the mask image generation model 15C is a model that detects an image part of information regarding identification of an operator on which a masking process is to be performed from an operation screen image on which a masking process has not yet been performed and then performs the masking process on the detected image part. A method for machine learning is not particularly limited. However, for example, random forest, neural network, support vector machine, or the like may be used. The mask image generation model 15C generated by the learning unit 11C is stored in the storing unit 15.

For example, the personal information masking unit 11D performs, using the mask image generation model 15C, a masking process on personal information of an operator in an operation screen image acquired by the acquisition unit 11B. Personal information of an operator is an example of information regarding identification of an operator. Personal information of an operator includes, for example, a username of the operator, an account ID, a facial image, an e-mail address, a telephone number, and the like. For example, a masking process may be performed on personal information of an operator using a pattern matching method, in place of the mask image generation model 15C.

For example, the estimation information masking unit 11E performs, using the mask image generation model 15C, a masking process on client information regarding a client that an operator is in charge of in an operation screen image acquired by the acquisition unit 11B. Client information is an example of information regarding identification of an operator. In the case where an operator is estimated from client information, a masking process is also performed on the client information. Furthermore, in the case where an operator is estimated from time period information, the estimation information masking unit 11E may also perform a masking process on the time period information. The time period information is information representing a time period during which an operator performs an operation and is an example of information regarding identification of the operator. For example, a masking process may be performed on client information and time period information using a pattern matching method or the like, in place of the mask image generation model 15C.

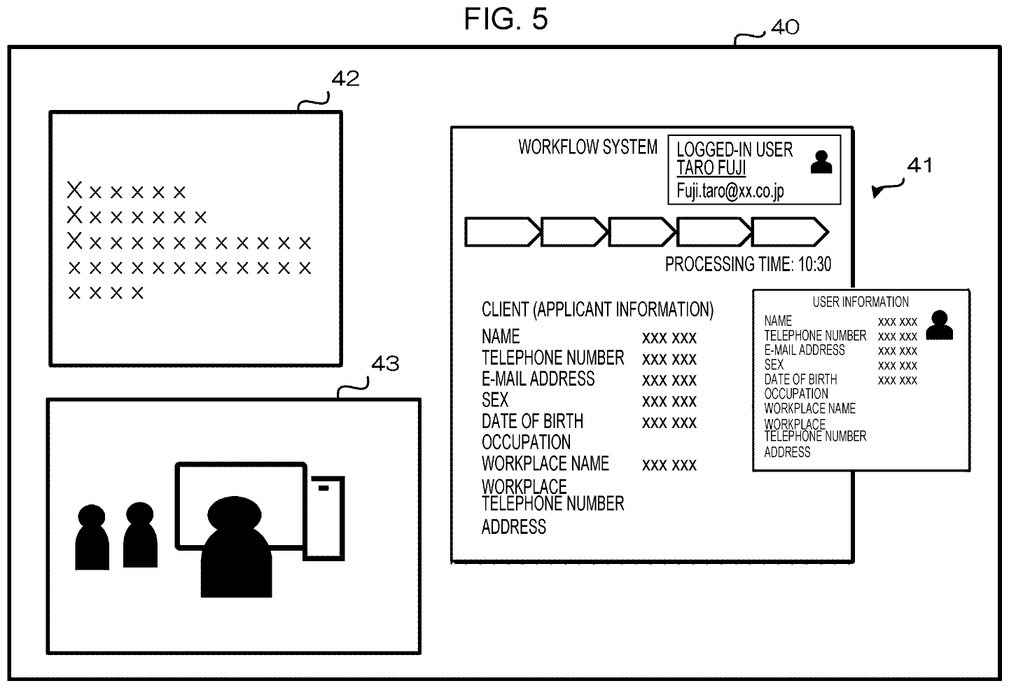

Next, a masking process on an operation screen image in an exemplary embodiment will be specifically described with reference to FIGS. 5, 6, and 7.

FIG. 5 is a diagram illustrating an example of an operation screen image 40 in an exemplary embodiment.

As illustrated in FIG. 5, the operation screen image 40 in this exemplary embodiment is an image obtained by recording an operation screen displayed on the client terminal 21. On the operation screen for the client terminal 21, a workflow system screen for the workflow system 100, a material screen that the operator refers to for an operation, and a video screen that the operator views for an operation are displayed at the same time. In this case, the operation screen image 40 obtained by recording the operation screen contains a workflow system screen image 41, a material screen image 42, and a video screen image 43. The workflow system screen image 41 is an image representing the workflow system screen, the material screen image 42 is an image representing the material screen, and the video screen image 43 is an image representing the video screen.

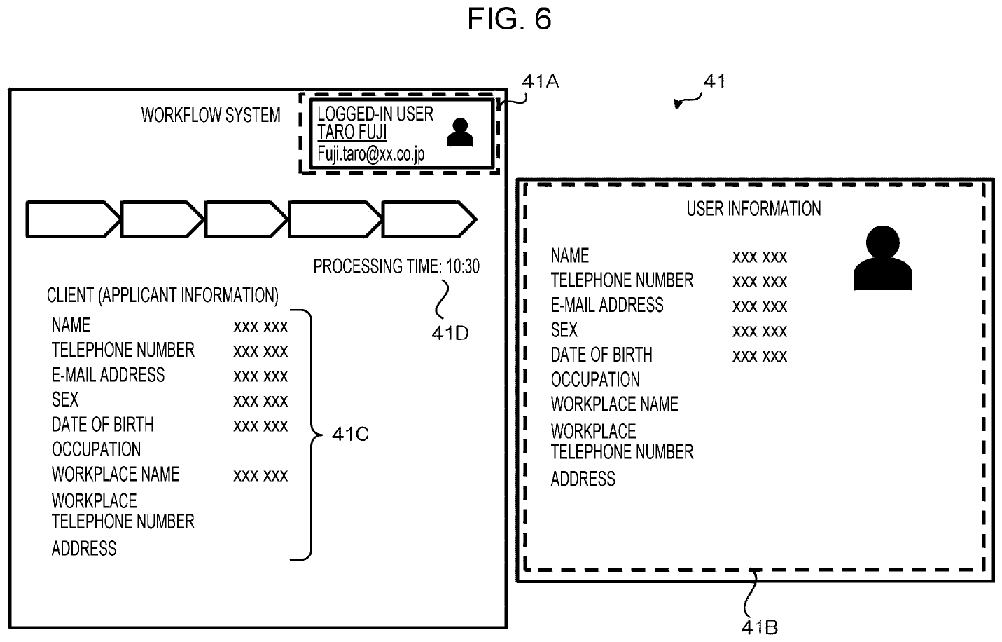

FIG. 6 is a diagram illustrating an example of the workflow system screen image 41 before a masking process is performed in an exemplary embodiment. In the example illustrated in FIG. 6, only the workflow system screen image 41 in the operation screen image 40 is illustrated.

As illustrated in FIG. 6, the workflow system screen image 41 in this exemplary embodiment includes login user information 41A, user information 41B, client information 41C, and processing time information 41D. The login user information 41A includes a username and an e-mail address of a user (operator) who has logged in and is an example of personal information of the operator. The user information 41B includes, for example, a username, an account ID, a facial image, an e-mail address, a telephone number, and the like and is an example of personal information of the operator. The client information 41C is an example of client information regarding a client that the operator is in charge of. The processing time information 41D is an example of time period information representing a time period during which the operator performs an operation.

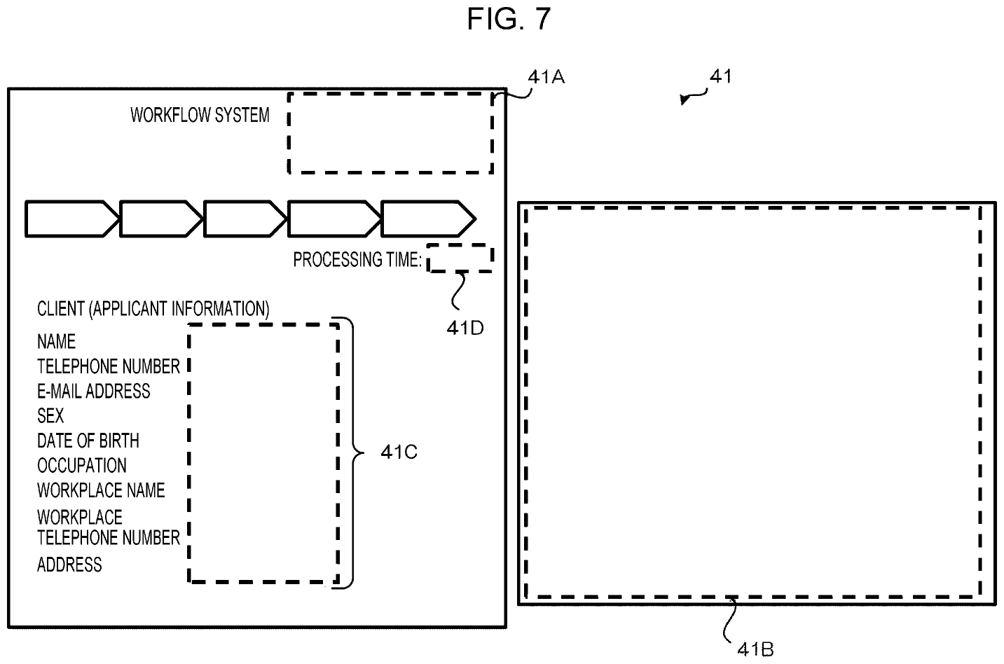

The personal information masking unit 11D performs, for example, as illustrated in FIG. 7, a masking process on the login user information 41A and the user information 41B, which are examples of personal information of the operator, in the operation screen image 40 acquired by the acquisition unit 11B.

The estimation information masking unit 11E performs, for example, as illustrated in FIG. 7, a masking process on the client information 41C, which is an example of client information regarding a client that the operator is in charge of, in the operation screen image 40 acquired by the acquisition unit 11B. In this case, for example, the estimation information masking unit 11E refers to the workflow DB 15B illustrated in FIG. 4. In the case where the number of operators who are in charge of a client identified from the client information 41C is less than or equal to a specific value (for example, 1), the estimation information masking unit 11E performs a masking process on the client information 41C. The specific value is not necessarily 1. For example, the specific value is appropriately set within a range from 1 or more to 5 or less.

The estimation information masking unit 11E may perform, for example, as illustrated in FIG. 7, a masking process on the processing time information 41D, which is an example of time period information representing a time period during which the operator performs an operation, in the operation screen image 40 acquired by the acquisition unit 11B. In this case, for example, the estimation information masking unit 11E refers to the workflow DB 15B illustrated in FIG. 4. In the case where the number of operators who are in charge of a client identified from the client information 41C is more than a specific value (for example, 1) and the number of operators who are in charge of the client during a time period identified from the processing time information 41D is less than or equal to a specific value (for example, 1), the estimation information masking unit 11E performs a masking process on the processing time information 41D.

FIG. 7 is a diagram illustrating an example of the workflow system screen image 41 after a masking process is performed in an exemplary embodiment. In the example illustrated in FIG. 7, only the workflow system screen image 41 in the operation screen image 40 is illustrated.

As illustrated in FIG. 7, in the workflow system screen image 41 in this exemplary embodiment, a masking process is performed on the login user information 41A, the user information 41B, the client information 41C, and the processing time information 41D. The masking process includes, for example, deletion of information, painting out of information (for example, information is painted out in a single color), and the like.

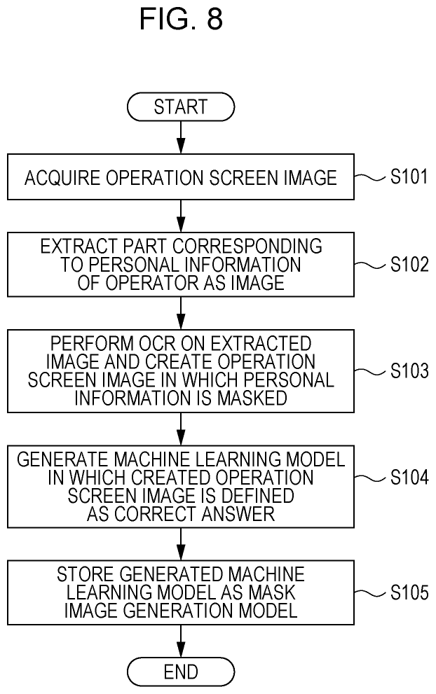

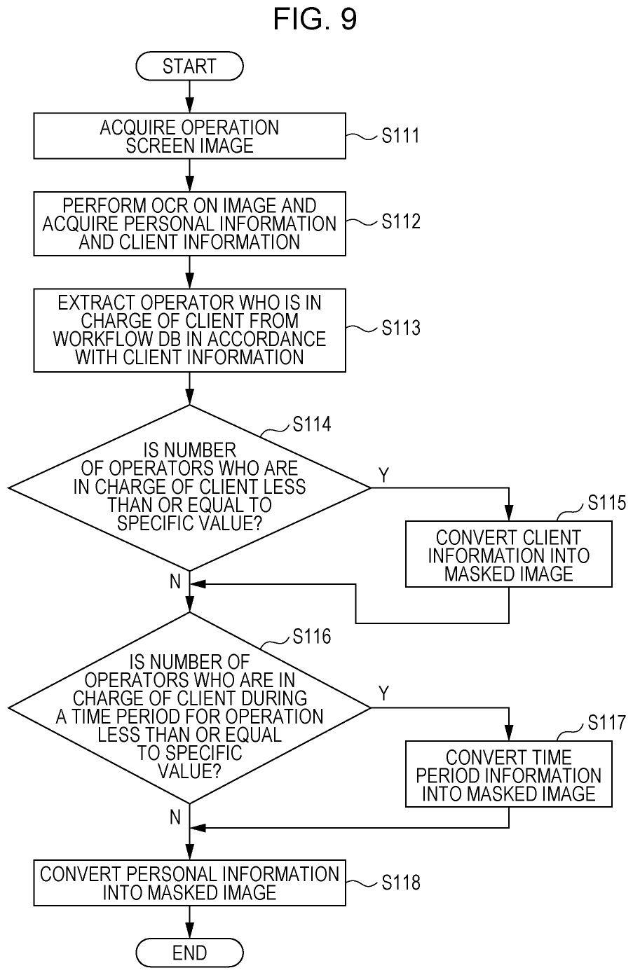

Next, an operation of the information processing apparatus 10 according to an exemplary embodiment will be described with reference to FIGS. 8 and 9.

FIG. 8 is a flowchart illustrating an example of the procedure of a learning process based on the information processing program 15A according to the first exemplary embodiment.

First, when an instruction for execution of a learning process is issued to the information processing apparatus 10, the CPU 11 activates the information processing program 15A and performs steps described below.

In step S101 in FIG. 8, the CPU 11 acquires an operation screen image obtained by recording an operation screen for the client terminal 21.

In step S102, the CPU 11 extracts a part corresponding to personal information of an operator as an image from the operation screen image acquired in step S101.

In step S103, the CPU 11 performs optical character recognition (OCR) on the image extracted in step S101, and creates an operation screen image in which the personal information of the operator (for example, an operator name, an e-mail address, a facial image, etc.) is masked on the basis of an OCR result.

In step S104, the CPU 11 generates a machine learning model for detecting, based on, as learning data, a pair of the masked operation screen image created in step S103 as correct data and the operation screen image before the masking process is performed, an image corresponding to personal information of the operator from the operation screen image before the masking process is performed.

In step S105, the CPU 11 stores the machine learning model generated in step S104 as the mask image generation model 15C into the storing unit 15, and ends the learning process based on the information processing program 15A.

FIG. 9 is a flowchart illustrating an example of the procedure of a masking process based on the information processing program 15A according to the first exemplary embodiment.

First, when an instruction for execution of a masking process is issued to the information processing apparatus 10, the CPU 11 activates the information processing program 15A and performs steps described below.

In step S111 in FIG. 9, the CPU 11 acquires an operation screen image (see, for example, FIG. 5) obtained by recording an operation screen for the client terminal 21.

In step S112, the CPU 11 performs OCR on the operation screen image acquired in step S111 to acquire personal information of an operator (for example, an operator name, an e-mail address, a facial address, etc.) and client information (for example, a client name, a client ID, an ID of a person in charge, etc.). At this time, the CPU 11 also acquires time period information of the operator.

In step S113, for example, the CPU 11 refers to the workflow DB 15B illustrated in FIG. 4 on the basis of the client information acquired in step S112, and extracts an operator (person in charge) who is in charge of the client. For example, in the case where the client ID of a client is “K00001”, “U00001” is extracted as an operator (person in charge) who is in charge of the client “K00001”. In the case where the client ID of a client is “K00002”, “U00005” and “U00015” are extracted as operators (persons in charge) who are in charge of the client “K00002”.

In step S114, the CPU 11 determines whether or not the number of operators (persons in charge) who are in charge of the client identified by the client information acquired in step S112 is less than or equal to a specific value. In the case where it is determined that the number of operators (persons in charge) who are in charge of the identified client is less than or equal to the specific value (for example, 1) (in the case where the determination result is affirmative), the process proceeds to step S115. In the case where it is determined that the number of operators (persons in charge) who are in charge of the identified client is not less than or equal to the specific value (for example, 1), that is, in the case where it is determined that the number of operators (persons in charge) who are in charge of the identified client is more than the specific value (in the case where the determination result is negative), the process proceeds to step S116.

In step S115, the CPU 11 converts, for example, using the mask image generation model 15C, the operation screen image acquired in step S111 into an image in which an image part representing the client information (for example, the client information 41C illustrated in FIG. 6) is masked, and the process proceeds to step S116. For example, in the case where the client ID of a client is “K00001” in the client table 151, the number of operators (persons in charge) is only one (“U00001”). Therefore, if the client information of “K00001” is displayed, there is a high probability that the operator (person in charge) will be identified. Thus, in the case where the number of operators (persons in charge) who are in charge of the identified client is less than or equal to a specific value (for example, 1), it is desirable that a masking process be also performed on the client information.

In step S116, the CPU 11 determines whether or not the number of operators (persons in charge) who are in charge of the client identified by the client information during the time period identified by the time period information acquired in step S112 is less than or equal to a specific value. In the case where it is determined that the number of operators (persons in charge) who are in charge of the identified client during the identified time period is less than or equal to a specific value (for example, 1) (in the case where the determination result is affirmative), the process proceeds to step S117. In the case where it is determined that the number of operators (persons in charge) who are in charge of the identified client during the identified time period is not less than or equal to the specific value (for example, 1), that is, in the case where it is determined that the number of operators (persons in charge) who are in charge of the identified client during the identified time period is more than the specific value (in the case where the determination result is negative), the process proceeds to step S118.

In step S117, the CPU 11 converts, for example, using the mask image generation model 15C, the operation screen image acquired in step S111 into an image in which an image part representing the time period information (for example, the processing time information 41D illustrated in FIG. 6) is masked, and the process proceeds to step S118. For example, in the case where the client ID of a client is “K00002” in the client table 151, the number of operators (persons in charge) is two (“U00005” and “U00015”). For example, the operator (person in charge) “U00005” performs an operation during a time period (for example, from 10:30 to 11:30). In this case, if the time period information of the client “K00002” is displayed, there is a high probability that the operator (person in charge) will be identified. Thus, even in the case where the number of operators (persons in charge) who are in charge of the identified client is two or more, when the number of operators (persons in charge) for the identified time period is less than or equal to a specific value (for example, 1), it is desirable that a masking process be also performed on the time period information of a time period during which an operation is performed.

For example, in the case where a work is done on a rotating basis among a plurality of staff members such as a reception desk of a bank, operators (persons in charge) take turns working during a predetermined time period. Therefore, even in the case where the number of operators (persons in charge) who are in change of a client is large, the operators (persons in charge) may be identified based on time periods. Thus, it is desirable that the masking process be also performed on the time period information, as described above.

In step S118, the CPU 11 converts, for example, using the mask image generation model 15C, the operation screen image acquired in step S111 into an image in which an image part representing the personal information (for example, the login user information 41A and the user information 41B illustrated in FIG. 6) is masked, and the series of processing actions by the information processing program 15A ends.

As described above, according to this exemplary embodiment, in the case where an operation screen image obtained by recording an operation screen for an operator with an excellent operation quality is used for education or the like of other operators, information regarding identification of the operator is protected. Therefore, an uncomfortable feeling that the operator gets when the operation screen for the operator is recorded and used may be relieved.

### Second Exemplary Embodiment

In the first exemplary embodiment described above, a case where an operator with an excellent operation quality is known in advance is described. In a second exemplary embodiment, a case where an operator with an excellent operation quality is identified on the basis of an operation history log will be described.

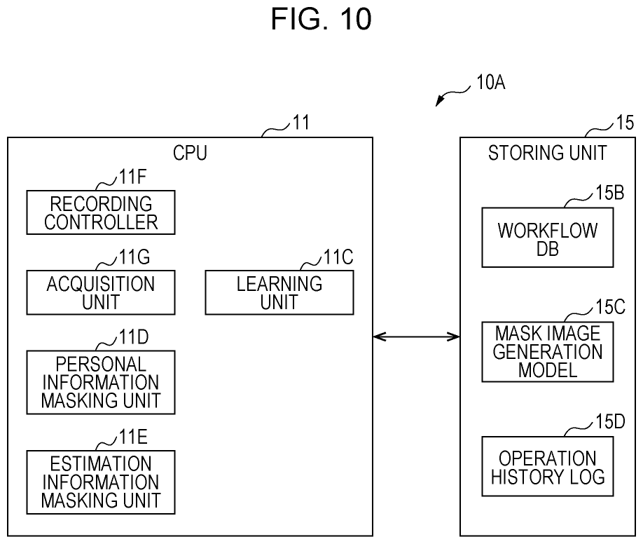

FIG. 10 is a block diagram illustrating an example of a functional configuration of an information processing apparatus 10A according to the second exemplary embodiment.

As illustrated in FIG. 10, the CPU 11 of the information processing apparatus 10A according to this exemplary embodiment functions as a recording controller 11F, an acquisition unit 11G, the learning unit 11C, the personal information masking unit 11D, and the estimation information masking unit 11E. The same components as those included in the information processing apparatus 10 in the first exemplary embodiment described above will be referred to with the same signs and redundant explanation will be omitted.

The workflow DB 15B, the mask image generation model 15C, and an operation history log 15D are stored in the storing unit 15 in this exemplary embodiment.

The operation history log 15D is record of an operation history of an operator. The operation history includes, for example, a processing time period spent for an operation, an index indicating the frequency of mistakes in an operation, and the like. The index indicating the frequency of mistakes in an operation does not necessarily indicate the frequency of direct mistakes and may be an index indirectly indicating the frequency of mistakes. For example, the “frequency of rework (send back)” or the like may be used as an index.

In this exemplary embodiment, a mode in which operation screen images obtained by recording operation screens for all the operators are acquired and an operation screen image for a specific operator (operator with an excellent operation quality) is selected from among the acquired operation screen images (hereinafter, referred to as a “first mode”) or a mode in which an operation screen image obtained by selectively recording an operation screen for a specific operator (operator with an excellent operation quality) is acquired (hereinafter, referred to as a “second mode”) may be used.

In the first mode, the acquisition unit 11G acquires operation screen images for all the operators recorded by the recording controller 11F. Then, the acquisition unit 11G identifies an operator who satisfies a predetermined condition regarding operation quality on the basis of the operation history log 15D, and selects an operation screen image for the identified operator from among the operation screen images for all the operators. The predetermined condition includes, for example, at least one of a condition that the processing time period is shorter than a specific period of time and a condition that an index indicating the frequency of mistakes is less than a specific value. That is, an operator who operates quickly and/or who makes less mistakes is identified.

In the second mode, the recording controller 11F performs control for identifying an operator who satisfies a predetermined condition regarding operation quality on the basis of the operation history log 15D and selectively recording an operation screen for the identified operator from among operation screens for operators. The acquisition unit 11G acquires an operation screen image obtained by selectively recording an operation screen for the identified operator by the recording controller 11F from among the operation screens for the operators. The predetermined condition includes, for example, at least one of a condition that the processing time period is shorter than a specific period of time and an index indicating the frequency of mistakes is less than a specific value, as in the first mode.

Furthermore, level of operation quality may be associated in advance with a user ID of an operator. In this case, when the operator logs into the workflow system 100, the level of operation quality is determined on the basis of the user ID. In the case where the determined level of operation quality is equal to or more than a specific level, the operator is determined to be an operator with an excellent operation quality. Thus, an operation screen image obtained by recording the operation screen for the identified operator may be acquired.

As described above, according to this exemplary embodiment, an operation screen for an operator with an excellent operation quality may be recorded in accordance with an operation history log and used.

### Third Exemplary Embodiment

In a third exemplary embodiment, a mode in which the line of sight of an operator is identified using an in-camera and a pointer (or a cursor) indicating the position of the identified line of sight is displayed on an operation screen will be described.

The client terminal 21 in this exemplary embodiment includes a line-of-sight detecting function for detecting the line of sight of an operator using an in-camera 21C. With the line-of-sight detecting function, a pointer (or a cursor) is displayed on an operation screen in conjunction with the position of a detected line of sight. The line-of-sight detecting function is implemented by a well-known technology. Each of the client terminals 22, 31, and 32 also includes the line-of-sight detecting function, as with the client terminal 21.

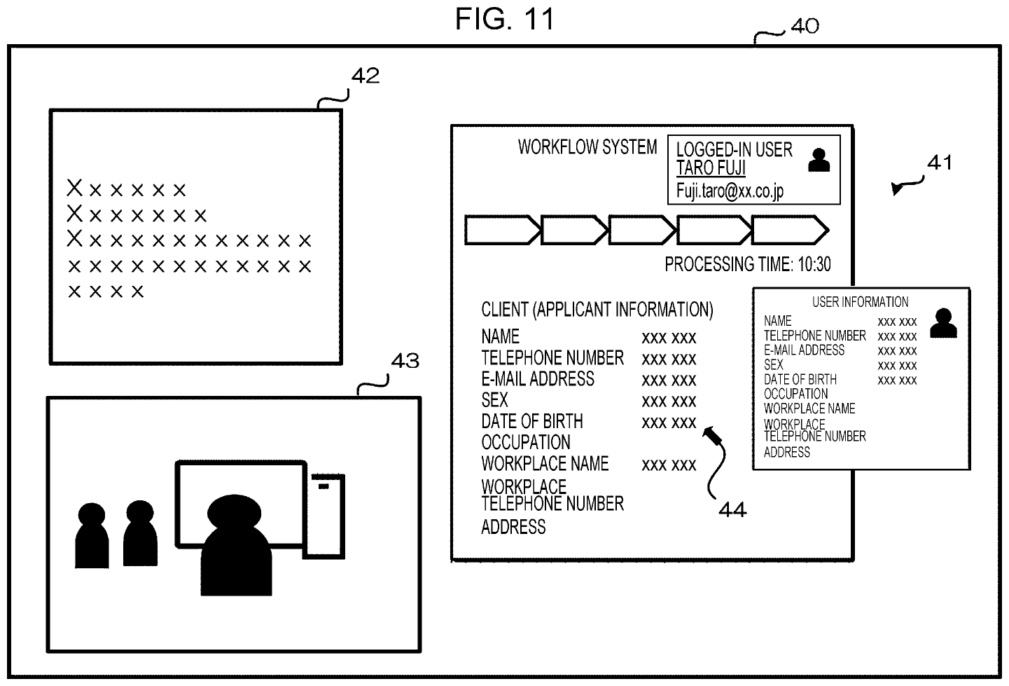

FIG. 11 is a diagram illustrating an example of the operation screen image 40 according to the third exemplary embodiment.

As illustrated in FIG. 11, the operation screen image 40 in this exemplary embodiment is an image obtained by recording an operation screen for the client terminal 21. The operation screen image 40 includes, as an image, a pointer (or a cursor) 44 that is displayed in conjunction with the line of sight of the operator.

The client terminal 21 may be configured not to include the in-camera 21C. For example, the pointer (or cursor) 44 is displayed at a position where an input is made using an input device such as a mouse or a keyboard. That is, the operation screen image 40 includes, as an image, the pointer (or cursor) 44 that is displayed in conjunction with a position where an input is made using the input device.

As described above, according to this exemplary embodiment, movement of the line of sight of an operator with an excellent operation quality, movement of the input device, and the like are displayed in an operation screen image. Thus, such an operation screen image serves as information useful for other operators.

Information processing apparatuses according to exemplary embodiments have been described as examples. A program for causing a computer to execute functions of units included in an information processing apparatus may also be included as an exemplary embodiment. A non-transitory computer readable recording medium on which such a program is recorded may also be included as an exemplary embodiment.

Configurations of information processing apparatuses according to exemplary embodiments described above are merely examples and may be changed according to the situation without departing from the scope of the present disclosure.

Furthermore, procedures of processes of programs according to exemplary embodiments described above are merely examples. Unnecessary steps may be deleted, new steps may be added, or processing order may be replaced without departing from the scope of the present disclosure.

Furthermore, a case where a process according to an exemplary embodiment is implemented by a software configuration using a computer when the program is executed is described in the foregoing exemplary embodiment. However, the present disclosure is not limited to this case. For example, an exemplary embodiment may be implemented by a hardware configuration or a combination of a hardware configuration and a software configuration.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire an image representing an operation screen on which progress of a work is displayed in accordance with a procedure of the work and on which an operator performs an operation, the image being obtained by recording the operation screen; and
perform a masking process on information regarding identification of the operator in the acquired image.

2. The information processing apparatus according to claim 1, wherein the information regarding identification of the operator includes personal information of the operator.

3. The information processing apparatus according to claim 1, wherein the information regarding identification of the operator includes client information regarding a client that the operator is in charge of.

4. The information processing apparatus according to claim 2, wherein the information regarding identification of the operator includes client information regarding a client that the operator is in charge of.

5. The information processing apparatus according to claim 3, wherein the processor is configured to, in a case where the number of operators who are in charge of the client identified from the client information is less than or equal to a specific value, perform the masking process on the client information.

6. The information processing apparatus according to claim 4, wherein the processor is configured to, in a case where the number of operators who are in charge of the client identified from the client information is less than or equal to a specific value, perform the masking process on the client information.

7. The information processing apparatus according to claim 5,
wherein the information regarding identification of the operator further includes time period information representing a time period during which the operator performs the operation, and
wherein the processor is configured to, in a case where the number of operators who are in charge of the client is more than the specific value and the number of operators who are in charge of the client during the time period identified from the time period information is less than or equal to the specific value, perform the masking process on the time period information.

8. The information processing apparatus according to claim 6,
wherein the information regarding identification of the operator further includes time period information representing a time period during which the operator performs the operation, and wherein the processor is configured to, in a case where the number of operators who are in charge of the client is more than the specific value and the number of operators who are in charge of the client during the time period identified from the time period information is less than or equal to the specific value, perform the masking process on the time period information.

9. The information processing apparatus according to claim 1, wherein the processor is configured to:
identify an operator who satisfies a predetermined condition regarding operation quality from operation history logs in which operation histories for individual operators are recorded; and
select the image for the identified operator from among the acquired images for the individual operators.

10. The information processing apparatus according to claim 2, wherein the processor is configured to:
identify an operator who satisfies a predetermined condition regarding operation quality from operation history logs in which operation histories for individual operators are recorded; and
select the image for the identified operator from among the acquired images for the individual operators.

11. The information processing apparatus according to claim 3, wherein the processor is configured to:
identify an operator who satisfies a predetermined condition regarding operation quality from operation history logs in which operation histories for individual operators are recorded; and
select the image for the identified operator from among the acquired images for the individual operators.

12. The information processing apparatus according to claim 4, wherein the processor is configured to:
identify an operator who satisfies a predetermined condition regarding operation quality from operation history logs in which operation histories for individual operators are recorded; and
select the image for the identified operator from among the acquired images for the individual operators.

13. The information processing apparatus according to claim 5, wherein the processor is configured to:
identify an operator who satisfies a predetermined condition regarding operation quality from operation history logs in which operation histories for individual operators are recorded; and
select the image for the identified operator from among the acquired images for the individual operators.

14. The information processing apparatus according to claim 6, wherein the processor is configured to:
identify an operator who satisfies a predetermined condition regarding operation quality from operation history logs in which operation histories for individual operators are recorded; and
select the image for the identified operator from among the acquired images for the individual operators.

15. The information processing apparatus according to claim 7, wherein the processor is configured to:
identify an operator who satisfies a predetermined condition regarding operation quality from operation history logs in which operation histories for individual operators are recorded; and
select the image for the identified operator from among the acquired images for the individual operators.

16. The information processing apparatus according to claim 8, wherein the processor is configured to:
identify an operator who satisfies a predetermined condition regarding operation quality from operation history logs in which operation histories for individual operators are recorded; and
select the image for the identified operator from among the acquired images for the individual operators.

17. The information processing apparatus according to claim 1, wherein the processor is configured to:
identify an operator who satisfies a predetermined condition regarding operation quality from operation history logs in which operation histories for individual operators are recorded; and
acquire an image obtained by selectively recording an operation screen for the identified operator from among the operation screens for the individual operators.

18. The information processing apparatus according to claim 2, wherein the processor is configured to:
identify an operator who satisfies a predetermined condition regarding operation quality from operation history logs in which operation histories for individual operators are recorded; and
acquire an image obtained by selectively recording an operation screen for the identified operator from among the operation screens for the individual operators.

19. The information processing apparatus according to claim 9,
wherein the operation histories each include a processing time period spent for an operation and an index indicating frequency of mistakes in the operation, and
the predetermined condition includes at least one of a condition that the processing time period is shorter than a specific period of time and the index indicating the frequency of mistakes is less than a specific value.

20. A non-transitory computer readable medium storing a program causing a computer to execute a process for information processing, the process comprising:
acquiring an image representing an operation screen on which progress of a work is displayed in accordance with a procedure of the work and on which an operator performs an operation, the image being obtained by recording the operation screen; and
performing a masking process on information regarding identification of the operator in the acquired image.
